(19) United States
(12) Patent Application Publication
(10) Pub. No.: US 2025/0267707 A1
(43) Pub. Date: Aug. 21, 2025

(54) DATA TRANSMISSION METHOD, DEVICE AND SYSTEM

(71) Applicant: SONIX TECHNOLOGY CO., LTD., Zhubei City (TW)

(72) Inventors: HAN-YI CHIU, Zhubei City (TW); Kun-Ming Huang, Zhubei City (TW)

(21) Appl. No.: 19/053,857

(22) Filed: Feb. 14, 2025

(30) Foreign Application Priority Data
Feb. 15, 2024 (TW) 113201648

(51) Int. Cl. H04W 74/0816; H04L 67/568; H04W 8/22; H04W 84/10

(52) U.S. Cl. CPC H04W 74/0816; H04L 67/568; H04W 8/22; H04W 84/10

(57) ABSTRACT

The present utility model provides a data transmission system, including: a remote device having a data transmission device and connecting a proprietary WiFi network; a relay device having a memory and a data transmission device and connecting the proprietary WiFi network and a default WiFi network. The remote device sends a first signal to the relay device through the proprietary WiFi network, the relay device receives the first signal and temporarily stores or stores the first signal in the memory, and sends the first signal to the local device through the default WiFi network; where anti-interference capability of the proprietary WiFi network is greater than anti-interference capability of the default WiFi network, and a transmission distance of the proprietary WiFi network is greater than a transmission distance of the default WiFi network.

### CROSS-REFERENCE TO RELATED APPLICATIONS

This application claims priority to Patent Application No. 113201648 of Taiwan, China, filed on Feb. 15, 2024. The disclosure of the aforementioned application is hereby incorporated by reference in its entirety.

### TECHNICAL FIELD

Embodiments of the present application relate to the field of communication technology, in particular to a data transmission method, an apparatus, a device and a system.

### BACKGROUND

In some scenarios, wireless communication is required between a remote device and a local device. For example, the remote device can be an image doorbell, while the local device can be the user's mobile phone.

In related technologies, the remote device and the local device can communicate through the standard wireless network communication technology (WiFi). However, as mentioned above, the standard WiFi operating on 2.4 GHz band is susceptible to interference, limiting the data transmission over long distances. Therefore, the data transmission between the remote device and the local device typically occurs over short-distances.

### SUMMARY

Embodiments of the present application provide a data transmission method to increase the distance of data transmission between the remote device and the local device.

In a first aspect, an embodiment of the present application provides a data transmission method, including:
sending, by a remote device, a first signal to a relay device through a proprietary WiFi network, where the relay device is configured to temporarily store or store the first signal, and sending the first signal to the local device through a default WiFi network;
where a transmission distance of the proprietary WiFi network is greater than a transmission distance of the default WiFi network.

In a possible implementation, the default WiFi network is a standard WiFi network.

In a possible implementation, anti-interference capability of the proprietary WiFi network is greater than anti-interference capability of the default WiFi network.

In a possible implementation, a network parameter of the proprietary WiFi network is different from a network parameter of the default WiFi network;

where the network parameter includes at least one of: a transmission protocol, a transmission mode, a response mechanism, or a channel switching mechanism.

In a possible implementation, the network parameter of the proprietary WiFi network satisfies at least one of:
a b/n hybrid transmission mode is adopted;
a transmission protocol adopted in an 802.11b mode is a Carrier Sense Multiple Access with Collision Avoidance (CSMA/CA) transmission protocol, and a priority of the CSMA/CA transmission protocol is greater than a default priority;
a transmission mode adopted in an 802.11n mode is an Enhanced Distributed Channel Access (EDCA) transmission mode;
a CTS-to-self protection mechanism is adopted;
an adopted response mechanism is to correspond multiple transmission packets with an acknowledgment character (ACK) response and disable ACK
a channel switching mechanism is: a channel switching is performed when a transmission accuracy is less than or equal to a default threshold.

In a possible implementation, the method further includes:
receiving, by the remote device, a third signal sent by the relay device through the proprietary WiFi network;
where the third signal is received by the relay device from the local device through the default WiFi network.

In a second aspect, an embodiment of the present application provides a data transmission method, including:
sending, by a remote device, a first signal to a relay device through a proprietary WiFi network, where the relay device is configured to temporarily store or store the first signal, and generating a second signal.

In a possible implementation, a network parameter of the proprietary WiFi network is different from a network parameter of the standard WiFi network;
where the network parameter includes at least one of: a transmission protocol, a transmission mode, a response mechanism, or a channel switching mechanism.

In a possible implementation, a network parameter of the proprietary WiFi network satisfies at least one of:
a b/n hybrid transmission mode is adopted;
a transmission protocol adopted in an 802.11b mode is a Carrier Sense Multiple Access with Collision Avoidance (CSMA/CA) transmission protocol, and a priority of the CSMA/CA transmission protocol is greater than a default priority;
a transmission mode adopted in an 802.11n mode is an Enhanced Distributed Channel Access (EDCA) transmission mode;
a CTS-to-self protection mechanism is adopted;
an adopted response mechanism is to correspond multiple transmission packets with an acknowledgment character (ACK) response and disable ACK management mechanism by hardware (HW) control;
a channel switching mechanism is: a channel switching is performed when a transmission accuracy is less than or equal to a default threshold.

In a possible implementation, the method further includes:
receiving, by the remote device, a third signal sent by the relay device through the proprietary WiFi network;
where the third signal is received by the relay device from the local device through the standard WiFi network.

In a third aspect, an embodiment of the present application provides a data transmission method, including:
receiving, by a relay device, a first signal sent by a remote device through a proprietary WiFi network;
temporarily storing or storing, by the relay device, the first signal, and sending the first signal to a local device through a default WiFi network;
where anti-interference capability of the proprietary WiFi network is greater than anti-interference capability of the default WiFi network, and a transmission distance of the proprietary WiFi network is greater than a transmission distance of the default WiFi network.

In a possible implementation, a network parameter of the proprietary WiFi network is different from a network parameter of the default WiFi network;
where the network parameter includes at least one of: a transmission protocol, a transmission mode, a response mechanism, or a channel switching mechanism.

In a possible implementation, a network parameter of the proprietary WiFi network satisfies at least one of:
a b/n hybrid transmission mode is adopted;
a transmission protocol adopted in an 802.11b mode is a Carrier Sense Multiple Access with Collision Avoidance (CSMA/CA) transmission protocol, and a priority of the CSMA/CA transmission protocol is greater than a default priority;
a transmission mode adopted in an 802.11n mode is an Enhanced Distributed Channel Access (EDCA) transmission mode;
a CTS-to-self protection mechanism is adopted;
an adopted response mechanism is to correspond multiple transmission packets with an acknowledgment character (ACK) response and disable ACK management mechanism by HW control;
a channel switching mechanism is: a channel switching is performed when a transmission accuracy is less than or equal to a default threshold.

In a possible implementation, the method further includes:
receiving, by the relay device, a third signal sent by the local device through the default WiFi network;
temporarily storing or storing, by the relay device, the third signal, and sending the third signal to the remote device through the proprietary WiFi network.

Embodiments of the present application provide a data transmission method, the remote device can send the first signal to the relay device through the proprietary WiFi network, after receiving the first signal through the proprietary WiFi network, the relay device can temporarily stores or stores the first signal, and send the first signal to the local device through the default WiFi network. As the relay device may be arranged between the remote device and the local device. The remote device and the relay device can communicate through the proprietary WiFi network, and the relay device and the local device can communicate through the default WiFi network, and the anti-interference capability and the transmission distance of the proprietary WiFi network are both greater than those of the default WiFi network, the distance between the remote device and the local device for data transmission is increased compared with the direct communication between the remote device and the local device through the default WiFi network.

### BRIEF DESCRIPTION OF DRAWINGS

FIG. 1 is a schematic diagram of the application scenario provided by an embodiment of the present application.

FIG. 2 is a schematic flowchart of a data transmission method provided by an embodiment of the present application.

FIG. 3 is a schematic flowchart of another data transmission method provided by an embodiment of the present application.

FIG. 4 is a schematic flowchart of yet another data transmission method provided by an embodiment of the present application.

FIG. 5 is a first specific example diagram of a data transmission method provided by an embodiment of the present application.

FIG. 6A is a second specific example diagram of a data transmission method provided by an embodiment of the present application.

FIG. 6B is a third specific example diagram of a data transmission method provided by an embodiment of the present application.

FIG. 7 is a fourth specific example diagram of a data transmission method provided by an embodiment of the present application.

FIG. 8 is a first schematic structural diagram of a data transmission device provided by an embodiment of the present application.

FIG. 9 is a second schematic structural diagram of a data transmission device provided by an embodiment of the present application.

FIG. 10 is a third schematic structural diagram of a data transmission device provided by an embodiment of the present application.

FIG. 11 is a fourth schematic structural diagram of a data transmission device provided by an embodiment of the present application.

FIG. 12 is a fifth schematic structural diagram of a data transmission device provided by an embodiment of the present application.

FIG. 13 is a schematic structural diagram of a remote device provided by an embodiment of the present application.

FIG. 14 is a schematic structural diagram of a relay device provided by an embodiment of the present application.

FIG. 15 is a schematic structural diagram of another relay device provided by an embodiment of the present application.

### DESCRIPTION OF EMBODIMENTS

Exemplary embodiments are described in detail here, and examples are shown in the drawings. When the following description relates to drawings, the same number in different drawings represents the same or similar features, unless otherwise indicated. The embodiments described in the following exemplary embodiments do not represent all embodiments consistent with the present application. Rather, they are merely examples of equipment and method that are consistent with some aspects of the present application as detailed in the attached claims.

It should be noted that, in this context, the term “including”, “having” or any other variation thereof is intended to cover non-exclusive inclusions, so that a process, a method, an article or a device that includes a series of elements includes not only those elements, but also other elements that are not expressly listed, or that are inherent to such a process, a method, an article or a device. In the absence of further restrictions, an element defined by the phrase “including a . . . ” does not preclude the existence of other identical elements in the process, the method, the article or the device that includes that element.

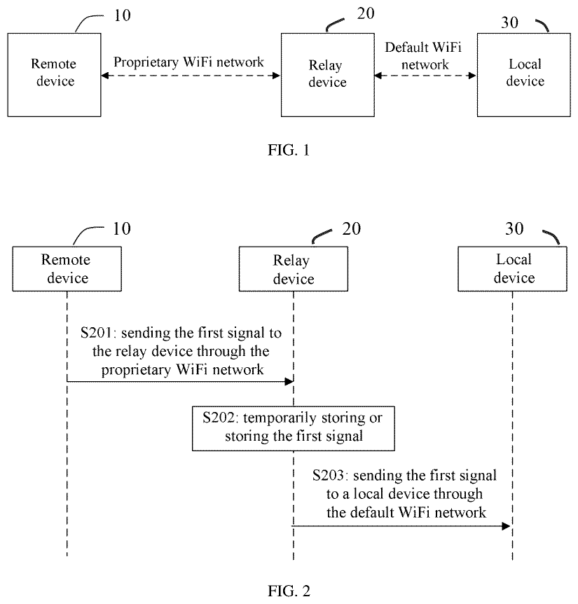

For ease of understanding, the following is a description of the application scenarios to which the embodiments of the present case are applied, in conjunction with FIG. 1.

FIG. 1 is a schematic diagram of the application scenario provided by an embodiment of the present application. Referring to FIG. 1, the data transmission system in the present case includes a remote device 10, a relay device 20 and a local device 30.

The remote device 10 and the relay device 20 can communicate through a proprietary WiFi network, and the relay device 20 and the local device 30 can communicate through a default WiFi network. The default WiFi network can be a standard WiFi network, for example, a standard WiFi network can be an IEEE 802.11b/g/n/ax standard network. The anti-interference capability of the proprietary WiFi network can be greater than the anti-interference capability of the default WiFi network, and the transmission distance of the proprietary WiFi network can be greater than the transmission distance of the default WiFi network. For example, if the remote device 10 is an image doorbell and the local device 30 is the user's mobile phone, the image doorbell can obtain image data of the visitor and send a first signal to the relay device 20 through the proprietary WiFi network, and the first signal may include the image data of the visitor. After receiving the first signal, the relay device can temporarily store or store the first signal and send the first signal to the user's mobile phone through the default WiFi network.

In this embodiment, a relay device 20 may be arranged between the remote device 10 and the local device 30. The remote device 10 and the relay device 20 can communicate through the proprietary WiFi network, and the relay device 20 and the local device 30 can communicate through the default WiFi network. Because the anti-interference capability and the transmission distance of the proprietary WiFi network are both greater than those of the default WiFi network, the distance between the remote device 10 and the local device 30 for data transmission can be increased compared with the direct communication between the remote device 10 and the local device 30 through the default WiFi network.

The technical content of the present case is explained below through specific embodiments. It should be noted that the following embodiments may exist separately or in combination with each other, and for the same or similar content, they will not be repeated in different embodiments.

FIG. 2 is a schematic flowchart of a data transmission method provided by an embodiment of the present application. Referring to FIG. 2, the method includes the following steps.

Step S201: the remote device 10 sends the first signal to the relay device 20 through the proprietary WiFi network. The remote device 10 can be a device capable of wireless communication. In an implementation the remote device 10 may include at least one of the following: the vehicle-mounted camera, the image doorbell or the baby monitor. The relay device 20 can be a network device capable of temporarily storing, storing or forwarding data and supporting the proprietary WiFi network and default WiFi network. For example, the relay device 20 can be a router that supports the proprietary WiFi network and the default WiFi network.

In an embodiment, the network parameter of the proprietary WiFi network is different from that of the default WiFi network; where the network parameter includes at least one of: a transmission protocol, a transmission mode, a response mechanism, or a channel switching mechanism.

In the technical scheme of the present case, since the proprietary WiFi network is different from the default WiFi network in at least one network parameter, such as the transmission protocol, the transmission mode, the response mechanism or the channel switching mechanism, the anti-interference capability of the proprietary WiFi network can be greater than the anti-interference capability of the default WiFi network, and the transmission distance of the proprietary WiFi network is greater than the transmission distance of the default WiFi network. For example, if the remote device 10 is an image doorbell, the image doorbell can obtain the image data of the visitor and send the first signal to the relay device through the proprietary WiFi network, and the first signal may include the image data of the visitor.

Step S202: the relay device 20 temporarily stores or stores the first signal. In an implementation, after receiving the first signal sent by the remote device 10 through the proprietary WiFi network, the relay device 20 can temporarily store or store the first signal. For example, if the remote device 10 is an image doorbell and the local device 30 is the user's mobile phone, after the relay device 20 receives the first signal sent by the image doorbell through the proprietary WiFi network, the relay device 20 can temporarily store or store the first signal.

Step S203: the relay device 20 sends the first signal to a local device 30 through the default WiFi network. The local device 30 refers to a communication device that receives the first signal. The local device 30 includes at least one of: a user terminal, a vehicle-mounted terminal or a wireless access point. For example, the user terminal can be a mobile phone, a computer, or a customized handheld device with custom WiFi and preset WiFi.

The distance between the relay device 20 and the local device 30 may be smaller than the distance between the remote device 10 and the relay device 20. For example, the distance between the remote device 10 and the relay device 20 is 100 meters, and the distance between the relay device 20 and the local device 30 can be 50 meters. The default WiFi network can be a standard WiFi network, for example, the standard WiFi network can be an IEEE 802.11b/g/n/ax standard network.

In an implementation, the relay device 20 can send the first signal to the local device through the default WiFi network. For example, if the local device 30 is a user's mobile phone, the relay device 20 can send the first signal to the user's mobile phone through the default WiFi network, so that the user's mobile phone receives the first signal, and the first signal includes the image data of the visitor.

In an embodiment of the present application, the remote device 10 can send the first signal to the relay device 20 through the proprietary WiFi network, and after receiving the first signal through the proprietary WiFi network, the relay device 20 can temporarily store or store the first signal and send the first signal to the local device 30 through the default WiFi network. Since the relay device 20 can be set up between the remote device 10 and the local device 30. The remote device 10 and the relay device 20 can communicate through the proprietary WiFi network, and the relay device 20 and the local device 30 can communicate through the default WiFi network, and the anti-interference capability and the transmission distance of the proprietary WiFi network are both greater than those of the default WiFi network, and the present utility model can increase the distance of data transmission between the remote device 10 and the local device 30 compared with the direct communication between the remote device 10 and the local device 30 through the default WiFi network.

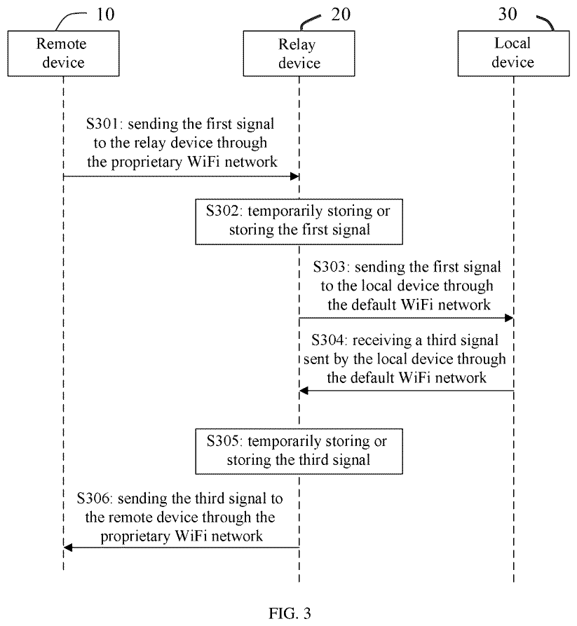

The following content is described in detail on the basis of the embodiment shown in FIG. 2 and in conjunction with FIG. 3. FIG. 3 is a schematic flowchart of another data transmission method provided by an embodiment of the present application. Referring to FIG. 3, the method includes the following steps.

Step S301: the remote device 10 sends the first signal to the relay device 20 through the proprietary WiFi network. In an implementation, the network parameter of the proprietary WiFi network satisfies at least one of: a transmission protocol adopted in the 802.11b mode is a carrier sense multiple access with collision void (CSMA/CA) transmission protocol, and a priority of the CSMA/CA transmission protocol is greater than a preset priority; a transmission mode adopted in 802.11n mode is an enhanced distributed channel access (EDCA) transmission mode; a CTS-to-self protection mechanism is adopted; a b/n hybrid transmission mode is adopted; an adopted response mechanism is to correspond multiple transmission packets with an acknowledge character (ACK) response and disable ACK management mechanism by HW control; the channel switching mechanism is: a channel switching is performed when a transmission accuracy is less than or equal to the preset threshold.

The preset priority refers to a priority of the default WiFi network. The priority of the CSMA/CA transmission protocol can be greater than the preset priority.

The EDCA transmission mode is a priority-based access mechanism for distributed channels. Data flows with different priorities can be scheduled and retransmitted to ensure different quality of service (QOS) for different data flows. The transmission efficiency can be improved and the transmission time can be shortened by the EDCA transmission mode. In an implementation, the priority of the proprietary WiFi network can be greater than the preset priority by adjusting the access category (AC) parameter in the EDCA transport mode.

The CTS-to-self protection mechanism refers to sending a control signal box called clear to send CTS (Clear to send) before occupying a channel to send data, and duration information is attached to the control signal box to inform other network devices not to occupy the channel within the duration, so as to avoid signal collision and conflict, and improve transmission efficiency.

In an implementation, there are multiple standards in a WiFi network, as shown in Table 1:

TABLE 1

| | | | | Operating frequency |
|---|---|---|---|---|
| WiFi version | WiFi standards | Highest rate | | band |
| WiFi 7 | IEEE 802.11be | 30 | Gbps | 2.4 GHz, 5 GHz, 6 GHz |
| WiFi 6 | IEEE 802.11ax | 11 | Gbps | 2.4 GHz, 5 GHz |
| WiFi 5 | IEEE 802.11ac | 1 | Gbps | 5 GHz |
| WiFi 4 | IEEE 802.11n | 600 | Mbps | 2.4 GHz, 5 GHz |
| WiFi 3 | IEEE 802.11g | 54 | Mbps | 2.4 GHz |
| WiFi 2 | IEEE 802.11b | 11 | Mbps | 2.4 GHz |
| WiFi 1 | IEEE 802.11a | 54 | Mbps | 5 GHz |
| WiFi 0 | IEEE 802.11 | 2 | Mbps | 2.4 GHz |

The b/n hybrid transmission mode refers to the WiFi network operating in a hybrid network mode using the IEEE 802.11b standard and the IEEE 802.11n standard. The proprietary WiFi network adopts the b/n hybrid transmission mode, with the design of using a non-standard custom packet format to transmit and disable ACK management mechanism by HW control, which can shorten the retransmission time.

In an implementation, the response mechanism can be to correspond multiple transmission packets with one ACK response and disable ACK management mechanism by HW control. For example, after the relay device 20 receives five transmission packets, the relay device 20 can send one acknowledgment character (ACK) response to the remote device 10 to feed back that the five transmission packets were received correctly.

The response mechanism adopted in the technical scheme of the present utility model can realize one ACK response corresponding to multiple transmission packets by disabling ACK management mechanism by HW control, there is no need to send an ACK response for each transmission packet, and the transmission time can be accurately calculated, which is conducive to the next data transmission and saves the transmission bandwidth.

In an implementation, the channel switching mechanism can be to switch the channel when the transmission accuracy is less than or equal to a default threshold.

In an implementation, the default threshold can be artificially preset, for example, the default pre-threshold can be 98%. For example, if the default pre-threshold is 98%, the channel switching mechanism can be: to switch the channel when the transmission accuracy is less than or equal to 98%, so as to switch to a channel with good network quality. The transmission distance of the signal can be increased through the channel switching mechanism.

For example, if the remote device 10 is an image doorbell, the image doorbell can obtain the image data of the visitor and send the first signal to the relay device 20 through the proprietary WiFi network, and the first signal may include the image data of the visitor.

Step S302: the relay device 20 temporarily stores or stores the first signal.

Step S303: the relay device 20 sends the first signal to the local device 30 through the default WiFi network.

It should be noted that the execution process of Step S302˜S303 can refer to Step S202˜S203 and will not be repeated here.

Step S304: the relay device 20 receives a third signal sent by the local device 30 through the default WiFi network. In an implementation, after the relay device 20 sends the first signal to the local device 30, the user can operate on the local device 30 to enable the local device 30 to generate the third signal; or, the local device 30 can generate the third signal based on the first signal. In an implementation, the third signal can be a control signal or a signal including audio and video data.

After generating the third signal, the local device 30 can send the third signal to the relay device 20 through the default WiFi network, so that the relay device 20 can receive the third signal sent by the local device 30 through the default WiFi network. For example, if the local device 30 is a user's mobile phone, the user can touch the “open” button on the mobile phone to cause the mobile phone to generate the third signal and send the third signal to the relay device 20 through the default WiFi network, then the relay device 20 can receive the third signal sent by the mobile phone through the default WiFi network. The third signal can be used to indicate the opening of the door lock.

Step S305: the relay device 20 temporarily stores or stores the third signal. In an implementation, after the relay device 20 receives the third signal sent by the local device 30 through the default WiFi network, the third signal can be temporarily stored or stored.

Step S306: the third signal that the relay device 20 sends to the remote device 10 through the proprietary WiFi network. In an implementation, after receiving the third signal sent by the local device 30 through the default WiFi network, the relay device 20 can temporarily store or store the third signal and send the third signal to the remote device 10 through the proprietary WiFi network, so that the remote device 10 receives the third signal sent by the relay device 20 through the proprietary WiFi network. For example, if the remote device 10 is an image doorbell and the local device 30 is a user's mobile phone, the relay device 20 can temporarily store or store the third signal after receiving the third signal sent by the user's mobile phone, and send the third signal to the image doorbell through the proprietary WiFi network. If the third signal is used to indicate the opening of the door lock, the image doorbell can open the door lock according to the third signal.

In an embodiment of the present application, the remote device 10 can send the first signal to the relay device 20 through the proprietary WiFi network, and after receiving the first signal, the relay device 20 can temporarily store or store the first signal and send the first signal to the local device 30 through the default WiFi network. The relay device 20 can receive the third signal sent by the local device through the default WiFi network, temporarily store or store the third signal, and send the third signal to the remote device 10 through the proprietary WiFi network. Since the relay device 20 can be set up between the remote device 10 and the local device 30, the remote device 10 and the relay device 20 can communicate through the proprietary WiFi network, the relay device 20 and the local device 30 can communicate through the default WiFi network, and the anti-interference capability and the transmission distance of the proprietary WiFi network are both greater than those of the default WiFi network, and the distance of data transmission between the remote device 10 and the local device 30 is increased compared with the direct communication between the remote device 10 and the local device 30 through the default WiFi network, users only need a device that can receive/send WiFi signals to use, without the limitation of WiFi transmission distance.

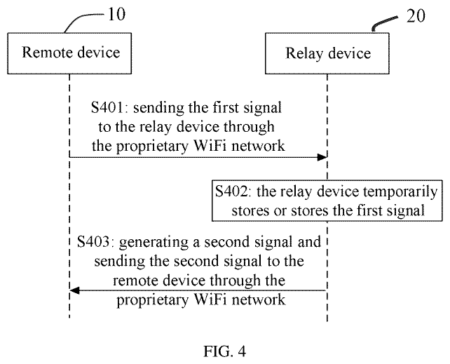

The data transmission methods shown in embodiments of FIG. 2 and FIG. 3 above are all performed in the presence of a local device 30. In the following, in conjunction with FIG. 4, the data transmission method is illustrated in the absence of a local device 30.

FIG. 4 is a schematic flowchart of yet another data transmission method provided by an embodiment of the present application. Referring to FIG. 4, the method may include the following steps.

Step S401: the remote device 10 sends the first signal to the relay device 20 through the proprietary WiFi network. In an implementation, the relay device 20 may be a network device with a display screen, capable of temporarily storing, storing or forwarding data, and supporting the proprietary WiFi network. For example, if the remote device 10 is a vehicle-mounted camera, the vehicle-mounted camera can collect the image data of the back of the vehicle, and send the first signal to the relay device through the proprietary WiFi network, and the first signal may include the image data from the back of the vehicle.

Step S402: the relay device 20 temporarily stores or stores the first signal. In an implementation, after receiving the first signal sent by the remote device 10 through the proprietary WiFi network, the relay device 20 can temporarily store or store the first signal. For example, if the remote device 10 is a vehicle-mounted camera, after the relay device 20 receives the first signal sent by the vehicle-mounted camera through the proprietary WiFi network, the relay device 20 can temporarily store or store the first signal.

Step S403: the relay device 20 generates a second signal and sends the second signal to the remote device 10 through the proprietary WiFi network. In an implementation, the relay device 20 can generate the second signal in response to the user's operation and send the second signal to the remote device 10 through the proprietary WiFi network. For example, if remote device 10 is a vehicle-mounted camera, if the user clicks the “turn off” button on the relay device 20, then the relay device 20 can generate the second signal in response to the user's click operation. The second signal may include a control command to turn off the vehicle-mounted camera. The relay device 20 can send the second signal to the vehicle-mounted camera through the proprietary WiFi network. After receiving the second signal, the vehicle-mounted camera can automatically turn off according to the second signal.

In an embodiment of the present application, the remote device 10 can send the first signal to the relay device 20 through the proprietary WiFi network. The relay device 20 can temporarily store or store the first signal, and generate the second signal, and then send the second signal to the remote device 10 through the proprietary WiFi network. Since the remote device 10 and the relay device 20 can communicate through the proprietary WiFi network, and the anti-interference capability and the transmission distance of the proprietary WiFi network are both greater than those of the default WiFi network, the distance of data transmission between the remote device and the relay device is increased compared with the communication between the remote device 10 and the relay device 20 using the default WiFi network.

In an implementation, an embodiment of the present utility model provide a data transmission system, the data transmission system may include a remote device 10 and a relay device 20, and the relay device 20 may have a display screen. The communication between the remote device 10 and the relay device 20 can be carried out through the proprietary WiFi network.

In an implementation, an embodiment of the present utility model provides another data transmission system, and the data transmission system may include a remote device 10, a relay device 20 and a local device 30, and the relay device 20 may not have a display screen. The remote device 10 can communicate with the relay device 20 through the proprietary WiFi network, and the relay device 20 can communicate with the local device 30 through the default WiFi network.

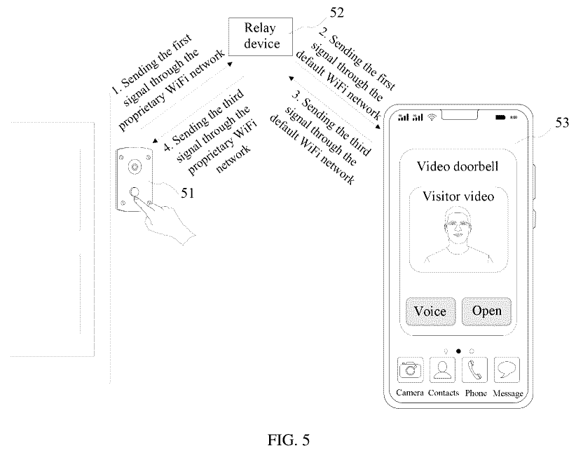

In the following, on the basis of any of the above embodiments, combined with FIG. 5 to FIG. 7, the above-mentioned data transmission process, and the data transmission system are further described in detail.

FIG. 5 is a first specific example diagram of a data transmission method provided by an embodiment of the present application. Referring to FIG. 5, the data transmission system may include an image doorbell 51, a relay device 52 and a user's mobile phone 53. The image doorbell 51 is a remote device, and the user's mobile phone 53 is a local device. An application (Application program, APP) for the image doorbell can be installed in the user's mobile phone 53. The image doorbell 51 and the relay device 52 can communicate through the proprietary WiFi network, and the relay device 52 and the user's mobile phone 53 can communicate through the default WiFi network.

In step 1, when a visitor is coming, the visitor can press the doorbell button. The image doorbell 51 obtains the image data of the visitor through the camera to generate the first signal. The first signal can include visitor image data. The image doorbell 51 can send the first signal to the relay device 52 through the proprietary WiFi network.

In step 2, after receiving the first signal, the relay device 52 can temporarily store or store the first signal. In an implementation, the user's mobile phone 53 can send an image obtaining request to the relay device 52, and the relay device 52 can send the first signal to the user's mobile phone 53 through the default WiFi network in response to the image obtaining request. The first signal includes the image data of the visitor.

In step 3, after the user's mobile phone 53 receives the first signal, the visitor image can be displayed according to the visitor image data in the first signal, and the user can watch the visitor image to confirm the identity of the visitor. On the interface of the image doorbell APP displayed by mobile phone, the user can click the “open” button, and user's mobile phone 53 can respond to the user's click operation, generate the third signal through image doorbell APP, and send the third signal to the relay device 52 through the default WiFi network. The third signal can be used to indicate the opening of the door lock.

In step 4, after receiving the third signal, the relay device 52 can temporarily store or store the third signal and send the third signal to the image doorbell 51 through the proprietary WiFi network. After the image doorbell 51 receives the third signal, the door lock can be opened according to the third signal.

In an implementation, in step 3, the user can also input a voice message, and the user's mobile phone 53 can generate a third signal in response to the voice information entered by the user, and send the third signal to the relay device 52 through the default WiFi network, and the third signal may include the voice message of the user. In step 4, after receiving the third signal, the relay device 52 can send the third signal to the image doorbell 51 through the proprietary WiFi network. This third signal may include the voice message of the user.

In an implementation, the image doorbell 51 may also have a talking apparatus that can play the voice message of the user according to the third signal, and can also capture the visitor's voice to enable the user to make a voice call to the visitor.

In an implementation, the user's mobile phone 53 can send an update software package to the relay device 52 through the default WiFi network, and after receiving the update software package, the relay device can send the update software package to the image doorbell 51 through the proprietary WiFi network, and after receiving the update software package, the image doorbell 51 can be updated according to the update software package.

In an embodiment of the present application, the remote device can send the first signal to the relay device through the proprietary WiFi network, and after receiving the first signal, the relay device may temporarily store or store the first signal and send the first signal to the local device through the default WiFi network. The relay device can receive the third signal sent by the local device through the default WiFi network, can temporarily store or store the third signal, and sends the third signal to the remote device through the proprietary WiFi network. Since a relay device can be set up between a remote device and a local device. The remote device and the relay device can communicate through the proprietary WiFi network, the relay device and the local device can communicate through the default WiFi network, and the anti-interference capability and the transmission distance of the proprietary WiFi network are greater than those of the default WiFi network, the distance of data transmission between the remote device and the local device is increased compared with the direct communication between the remote device and the local device through the default WiFi network, users only need a device that can receive/send WiFi signals to use, without the limitation of WiFi transmission distance.

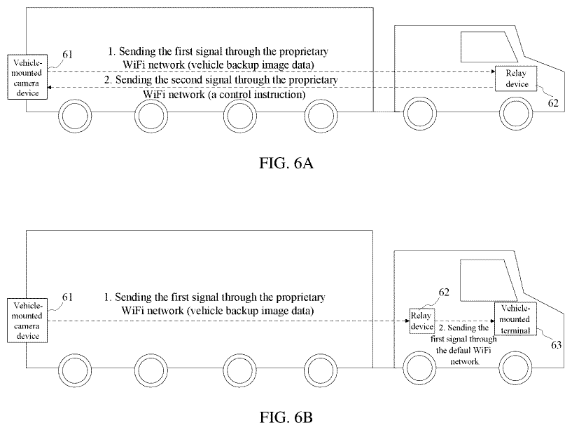

FIG. 6A is a second specific example diagram of a data transmission method provided by an embodiment of the present application. Referring to FIG. 6A, the data transmission system may include a vehicle-mounted camera 61 and a relay device 62. The vehicle-mounted camera 61 is a remote device, which can be installed on the car door. The relay device 62 can be a communication device arranged in the vehicle, and the relay device 62 can have a display screen and an audio playback apparatus. For example, the audio playback apparatus can be a speaker. The communication between vehicle-mounted camera 61 and relay device 62 can be carried out through the proprietary WiFi network.

In an implementation, a gravity sensor (g-sensor) can be installed in the vehicle. When the user starts to reverse, the vehicle-mounted camera 61 can respond to a turning on instruction sent by the gravity sensor to automatically turn on, and the turning on instruction is generated after the gravity sensor can detect the vehicle movement; or it may be turned on manually by the user.

In step 1, the vehicle-mounted camera 61 can capture the image data from the back of the vehicle to generate the first signal. The first signal may include image data from the back of the vehicle. The vehicle-mounted camera 61 can send the first signal to the relay device 62 through the proprietary WiFi network.

In step 2, as the relay device 62 has a display screen, after the relay device 62 receives the first signal, the first signal can be stored, and according to the image data from the back of the vehicle in the first signal, the vehicle back image is displayed, that is, the vehicle backup image. The user can reverse the vehicle based on the vehicle backup image.

In an implementation, when the user is in the process of reversing, the user may click the “broadcast” button on the relay device 62, and the second signal is broadcast to the back of car through vehicle-mounted camera. Or, after the user completes reversing, the user may click the “turn off” button on the relay device 62, and the relay device 62 can respond to the user's click operation, generate the second signal, where the second signal may include a control instruction, and the control instruction may be used to control the vehicle-mounted camera 61. The relay device 62 can send the second signal to the vehicle-mounted camera 61 through the proprietary WiFi network. The vehicle-mounted camera 61 can perform the corresponding action according to the control instruction in the second signal. For example, if the control command included in the second signal is to turn off the vehicle-mounted camera 61, the vehicle-mounted camera 61 can be automatically shut down according to the control instruction.

In an embodiment of the present application, the remote device may send the first signal to the relay device through the proprietary WiFi network, and the relay device may temporarily store or store the first signal and send the second signal to the remote device through the proprietary WiFi network. Since the remote device and the relay device can communicate through the proprietary WiFi network, and the anti-interference capability and the transmission distance of the proprietary WiFi network are greater than those of the default WiFi network, the distance of data transmission between the remote device and the relay device is increased compared with the communication between the remote device and the relay device using the default WiFi network.

FIG. 6B is a third specific example diagram of a data transmission method provided by an embodiment of the present application. Referring to FIG. 6B, the data transmission system may include a vehicle-mounted camera 61, a relay device 62 and a vehicle-mounted terminal 63. The vehicle-mounted camera 61 is a remote device and can be installed on the car door. The relay device 62 can be a communication device that is arranged in the vehicle and does not have a display screen. The vehicle-mounted terminal 63 is a local device, and the vehicle-mounted terminal may have a display screen. The vehicle-mounted camera 61 and the relay device 62 can communicate through the proprietary WiFi network, and the relay device 62 and the vehicle-mounted terminal 63 can communicate through the default WiFi network.

In step 1, the vehicle-mounted camera 61 can capture the image data from the back of the vehicle to generate the first signal. The first signal may include the image data from the back of the vehicle. The vehicle-mounted camera 61 can send the first signal to the relay device 62 through the proprietary WiFi network.

In step 2, after receiving the first signal, the relay device 62 can temporarily store or store the first signal and send the first signal to the vehicle-mounted terminal 63 through the default WiFi network. The first signal may include the image data from the back of the vehicle.

After receiving the first signal, the vehicle-mounted terminal 63 can display, according to the image data from the back of the vehicle in the first signal, the vehicle back image, that is, a vehicle backup image. The user can reverse the vehicle based on the vehicle backup image. In an implementation, after the user completes reversing, the user may click the “turn off” button on the vehicle-mounted terminal 63, and the vehicle-mounted terminal 63 can respond to the user's click operation, generate the third signal, and the third signal can be used to indicate the shutdown of the vehicle-mounted camera 61. The vehicle-mounted terminal 63 can send the third signal to the relay device 62 through the default WiFi network. After receiving the third signal, the relay device 62 can temporarily store or store the third signal, and send the third signal to the vehicle-mounted camera 61 through the proprietary WiFi network. The vehicle-mounted camera 61 can be automatically turned off according to the third signal.

In this embodiment, the remote device can send the first signal to the relay device 62 through the proprietary WiFi network, and after receiving the first signal, the relay device 62 can temporarily store or store the first signal and send the first signal to the local device through the default WiFi network. The relay device 62 can receive the third signal sent by the local device through the default WiFi network, temporarily store or store the third signal, and send the third signal to the remote device through the proprietary WiFi network. Since the relay device 62 can be set up between the remote device and the local device. The remote device and the relay device can communicate through the proprietary WiFi network, and the relay device and the local device can communicate through the default WiFi network, and the anti-interference capability and the transmission distance of the proprietary WiFi network are greater than those of the default WiFi network, and the distance of data transmission between the remote device and the local device is increased compared with the direct communication between the remote device and the local device through the default WiFi network.

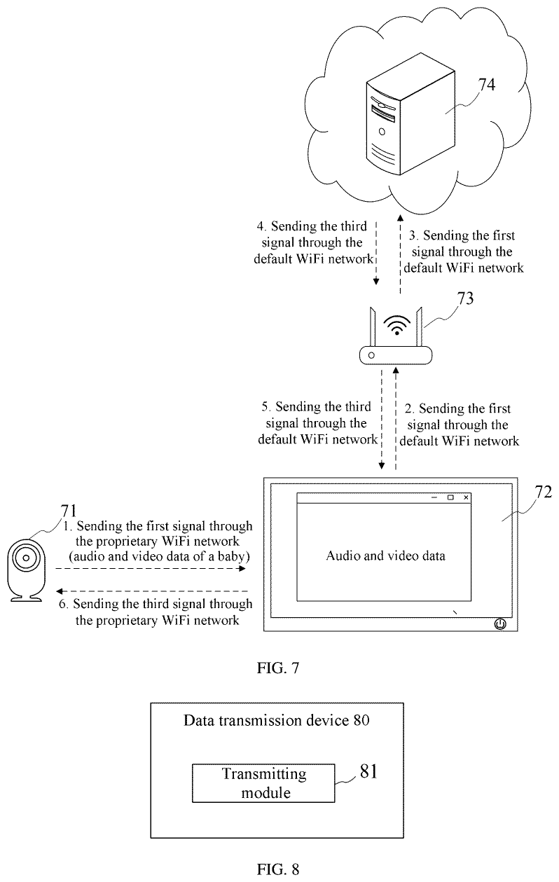

FIG. 7 is a fourth specific example diagram of a data transmission method provided by an embodiment of the present application. Referring to FIG. 7, the data transmission system may include a baby monitor 71, a display 72, a wireless access point 73 and a cloud server 74. The baby monitor 71 is a remote device, the display 72 is a relay device, and the wireless access point 73 is a local device. In an implementation, the display 72 may be a liquid crystal display (LCD). The operating mode of the wireless access point can include an access point (AP) mode and a wireless router (router) mode. The baby monitor 71 and the display 72 can communicate through the proprietary WiFi network, the display 72 and the wireless access point 73 can communicate through the default WiFi network, and the wireless access point 73 and the cloud server 74 can communicate through the default WiFi network.

In step 1, the baby monitor 71 can capture the audio and video data of a baby to generate the first signal. The first signal can include the audio and video data of the baby. The baby monitor 71 may send the first signal to the display 72 through the proprietary WiFi network. The transmission distance, the penetration and the anti-interference capability can be greatly improved by transmitting the first signal through the proprietary WiFi network.

In step 2, after receiving the first signal, the display 72 can temporarily store and/or store the first signal and send the first signal to the wireless access point 73 through the default WiFi network.

In step 3, the wireless access point 73 can send the first signal to the cloud server 74 through the default WiFi network, combined with the AP mode or the Router mode, so that the cloud server 74 stores the audio and video data of the baby. The user can log in to the application (Application program, APP) to obtain the audio and video data of the baby in the cloud server 74 to check the baby's condition at any time.

In step 4, the user can enable the cloud server 74 to send the third signal to the wireless access point 73 through the default WiFi network via an application. For example, the third signal may be used to instruct the baby monitor 71 to turn to the left.

In step 5, after receiving the third signal, the wireless access point 73 can send the third signal to the display 72 through the default WiFi network.

In step 6, the display 72 can send the third signal to the baby monitor 71 through the proprietary WiFi network. After receiving the third signal, the baby monitor 71 can turn to the left according to the third signal to adjust the monitoring range.

It should be noted that when the display 72 is connected to the wireless

access point 73, if the wireless access point 73 needs to enter an account and a password, the account and password can be entered in the login page displayed by the display 72 to connect the wireless access point 73.

In an implementation, the wireless access point 73 may also be a communication component in the display 72. When the wireless access point 73 is a communication component in the display 72, the cloud server 74 can be a local device. The display 72 can send the first signal to the cloud server 74 through the default WiFi network. If logging in to the cloud server 74 requires the entry of an account and password, the account and password can be entered in the login page displayed by the display 72 to connect to the cloud server 74.

In an embodiment of the present application, the remote device can send the first signal to the relay device through the proprietary WiFi network, and after receiving the first signal, the relay device can temporarily store or store the first signal and send the first signal to the local device through the default WiFi network. The relay device can receive the third signal sent by the local device through the default WiFi network, temporarily store or store the third signal, and send the third signal to the remote device through the proprietary WiFi network. As a relay device can be set up between a remote device and a local device. The remote device and the relay device can communicate through the proprietary WiFi network, and the relay device and the local device can communicate through the default WiFi network, and the anti-interference capability and the transmission distance of the proprietary WiFi network are greater than those of the default WiFi network, and the distance of data transmission between the remote device and the local device is increased compared with the direct communication between the remote device and the local device through the default WiFi network.

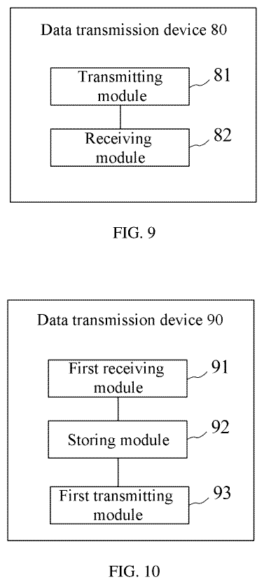

FIG. 8 is a first schematic structural diagram of a data transmission device provided by an embodiment of the present application, which is applied to a remote device, referring to FIG. 8, the data transmission device 80 includes a transmitting module 81, the transmitting module 81 is configured to send the first signal to a relay device through the proprietary WiFi network, the relay device is configured to temporarily store or store the first signal, and send the first signal to the local device through the default WiFi network. The anti-interference capability of the proprietary WiFi network is greater than the anti-interference capability of the default WiFi network, and the transmission distance of the proprietary WiFi network is greater than the transmission distance of the default WiFi network. The data transmission device provided in the embodiment of the present application can execute the technical solutions shown in the aforementioned method embodiments, the implementation principles and beneficial effects therebetween are similar, and will not be repeated here. FIG. 9 is a second schematic structural diagram of a data transmission device provided by an embodiment of the present application. Referring to FIG. 9, on the basis of the embodiment shown in FIG. 8, the data transmission device 80 further includes a receiving module 82, and the receiving module 82 is configured to receive the third signal sent by the relay device through the proprietary WiFi network, where the third signal is received by the relay device from the local device through the default WiFi network. The data transmission device provided in the embodiment of the present application can execute the technical solutions shown in the aforementioned method embodiments, the implementation principles and beneficial effects therebetween are similar, and will not be repeated here.

FIG. 10 is a third schematic structural diagram of a data transmission device provided by an embodiment of the embodiment of the present application, which is applied to a relay device, referring to FIG. 10, the data transmission device 90 includes a first receiving module 91, a storing module 92, and a first transmitting module 93, where the first receiving module 91 is configured to receive the first signal sent by a remote device through the proprietary WiFi network; the storing module 92 is configured to temporarily store or store the first signal; the first transmitting module 93 is configured to send the first signal to the local device through the default WiFi network. The anti-interference capability of the proprietary WiFi network is greater than the anti-interference capability of the default WiFi network, and the transmission distance of the proprietary WiFi network is greater than the transmission distance of the default WiFi network. The data transmission device provided in the embodiment of the present application can execute the technical solutions shown in the aforementioned method embodiments, the implementation principles and beneficial effects therebetween are similar, and will not be repeated here.

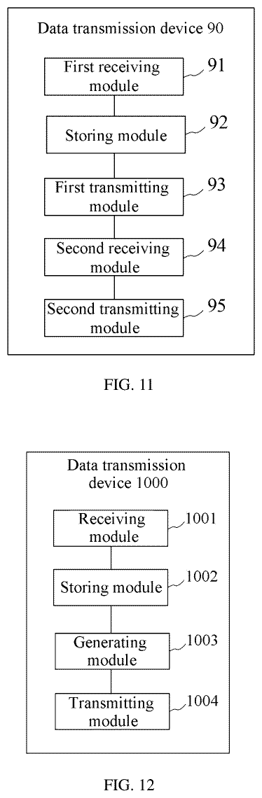

FIG. 11 is a fourth schematic structural diagram of a data transmission device provided by an embodiment of the present application, which is applied to a relay device, referring to FIG. 11, on the basis of the embodiment shown in FIG. 10, the device 90 further includes a second receiving module 94 and a second transmitting module 95, where the second receiving module 94 is configured to receive the third signal sent by the local device through the default WiFi network. In a possible implementation, the storing module 92 is further configured to temporarily store or store the third signal. In a possible implementation, the second transmitting module 95 is configured to send the third signal to the remote device through the proprietary WiFi network. The data transmission device provided in the embodiment of the present application can execute the technical solutions shown in the aforementioned method embodiments, the implementation principles and beneficial effects therebetween are similar, and will not be repeated here.

FIG. 12 is a fifth schematic structural diagram of a data transmission device provided by an embodiment of the present application, which is applied to relay device, referring to FIG. 12, the device 1000 includes a receiving module 1001, a storing module 1002, a generating module 1003 and a transmitting module 1004, where the receiving module 1001 is configured to receive the first signal sent by the remote device through the proprietary WiFi network; the storing module 1002 is configured to temporarily store or store the first signal; the generating module 1003 is configured to generate the second signal; the transmitting module 1004 is configured to send the second signal to a remote device through the proprietary WiFi network. The data transmission device provided in the embodiment of this utility model can execute the technical solutions shown in the aforementioned method embodiments, the implementation principles and beneficial effects therebetween are similar, and will not be repeated here.

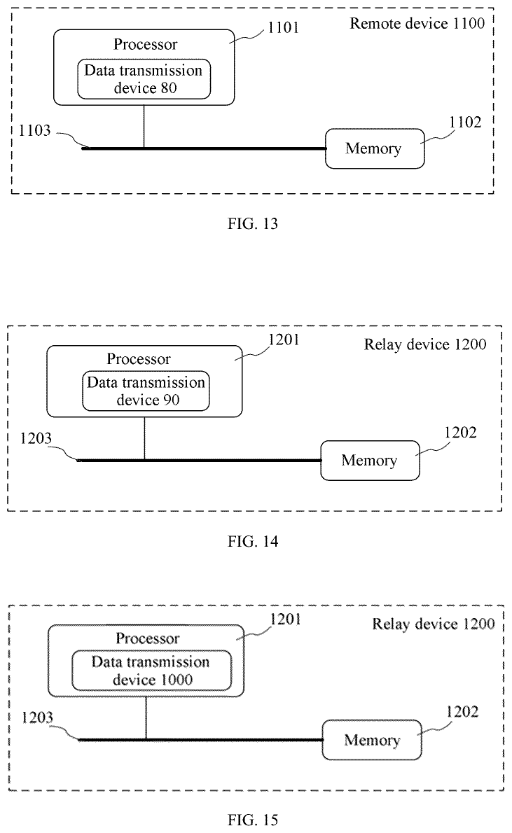

FIG. 13 is a schematic structural diagram of a remote device provided by an embodiment of the present application. Referring to FIG. 13, the remote device 1100 includes a processor 1101 and a memory 1102. By way of example, the processor 1101 and the memory 1102 are connected to each other through the bus 1103. The processor 1101 may include the data transmission device 80 shown in the embodiment of FIG. 8 or FIG. 9; the memory 1102 stores a computer-executed instruction; the processor 1101 executes the computer-executed instruction stored in the memory 1102, such that the processor 1101 executes the method shown in the above method embodiment.

FIG. 14 is a schematic structural diagram of a relay device provided by an embodiment of the present application. Referring to FIG. 14, the relay device 1200 includes a processor 1201 and a memory 1202. For example, the processor 1201 and the memory 1202 are connected to each other through the bus 1203. The processor 1201 may include the device 90 shown in the embodiment of FIG. 10 or FIG. 11; the memory 1202 stores a computer-executed instruction; the processor 1201 executes the computer-executed instruction stored in the memory 1202, such that the processor 1201 executes the method shown in the method embodiment above.

FIG. 15 is a schematic structural diagram of another relay device provided by an embodiment of the present application. Referring to FIG. 15, the relay device 1200 includes a processor 1201 and a memory 1202 may be included. For example, the processor 1201 and the memory 1202 are connected to each other through the bus 1203. The processor 1201 may include the device 1000 shown in the embodiment of FIG. 12; the memory 1202 stores a computer-executed instruction; the processor 1201 executes the computer-executed instruction stored in the memory 1202, such that the processor 1201 executes the method shown in the method embodiment above.

An embodiment of the present application provides a non-transitory computer-readable storage medium storing at least one computer instruction, where the computer instruction is used to enable the computer to perform the methods of the above embodiments.

An embodiment of the present application further provides a computer program product, including a computer program, characterized is that, when executed by a processor, the methods of the above embodiments is implemented. All or part of the steps to implement each of the above method embodiments can be completed by the hardware related to the program instructions. The aforementioned program can be stored in a readable memory. When the program is executed, a step including the above method embodiments is implemented; the aforementioned memory (storage media) includes: read-only memory (ROM), random access memory (RAM), flash memory, hard disk, solid state drive, magnetic tape, floppy disk, optical disc and any combination thereof.

The embodiments of the present invention are described with reference to the flow diagram and/or the block diagram of the method, the apparatus (system), and the computer program product according to the embodiment of the present application. It should be understood that each process and/or box in the flowchart and/or the block diagram, and the combination of the process and/or the box in the flowchart and/or the block diagram, can be implemented by the computer program instruction. This computer program instruction may be provided to the processing unit of a general-purpose computer, a specialized computer, an embedded processing machine, or other programmable data processing device to produce a machine such that the instructions executed by the processing unit of the computer or other programmable data processing device produce a device for accomplishing the functions specified in a flow diagram or processes and/or block diagram boxes or boxes.

These computer program instruction may also be stored in computer-readable memory capable of guiding a computer or other programmable data-processing device to work in a particular manner such that the instructions stored in the computer's readable memory result in a manufactured product including a directive device that implements the functions specified in a flowchart process or processes and/or block diagram boxes or boxes.

These computer program instructions may also be loaded onto a computer or other programmable data processing device such that a series of operational steps are performed on the computer or other programmable device to produce computer-implemented processing, whereby the instructions executed on the computer or other programmable device provide steps for implementing the function specified in one or more processes and/or block diagram boxes or boxes in a flowchart.

Obviously, a person skilled in the art may make various changes and variants to the embodiment of the present application without departing from the spirit and scope of the present application. Thus, if these modifications and variants of the embodiment of the present application fall within the scope of the claims of the present application and their equivalents, the present application is also intended to include such modifications and variants.

In the present application, the term “including” and its variants may refer to non-limiting including; the term “or” and its variations can refer to “and/or”. The terms “first”, “second”, etc., in the present application, are used to distinguish similar objects and do not have to be used to describe a particular order or sequence. For the purposes of this application, “multiple” means two or more of them. “And/or” describes the relationship between the associated objects, indicating that there can be three relationships, for example, A and/or B, which can represent: A alone, A and B at the same time, and B alone. The character “/” generally indicates that the relationship between the preceding and posting objects is an “or”. The foregoing is only a better embodiment of the present creation, and is not intended to limit the scope of patent protection of the present creation, so all equivalent changes made by using the description and schematic content of the creation are similarly included in the scope of protection of the rights of the present creation, and are collectively stated.

What is claimed is:

1. A data transmission method, comprising:
sending, by a remote device, a first signal to a relay device through a proprietary WiFi network, wherein the relay device is configured to temporarily store or store the first signal, and sending the first signal to the local device through a default WiFi network;
wherein a transmission distance of the proprietary WiFi network is greater than a transmission distance of the default WiFi network.

2. The method according to claim 1, wherein the default WiFi network is a standard WiFi network.

3. The method according to claim 1, wherein anti-interference capability of the proprietary WiFi network is greater than anti-interference capability of the default WiFi network.

4. The method according to claim 1, wherein a network parameter of the proprietary WiFi network is different from a network parameter of the default WiFi network;
wherein the network parameter comprises at least one of: a transmission protocol, a transmission mode, a response mechanism, or a channel switching mechanism.

5. The method according to claim 1, wherein a network parameter of the proprietary WiFi network satisfies at least one of:
a b/n hybrid transmission mode is adopted;
a transmission protocol adopted in an 802.11b mode is a Carrier Sense Multiple Access with Collision Avoidance (CSMA/CA) transmission protocol, and a priority of the CSMA/CA transmission protocol is greater than a default priority;
a transmission mode adopted in an 802.11n mode is an Enhanced Distributed Channel Access (EDCA) transmission mode;
a CTS-to-self protection mechanism is adopted;
an adopted response mechanism is to correspond multiple transmission packets with an acknowledgment character (ACK) response and disable ACK management mechanism by hardware (HW) control;
a channel switching mechanism is: a channel switching is performed when a transmission accuracy is less than or equal to a default threshold.

6. The method according to claim 1, wherein the method further comprises:
receiving, by the remote device, a third signal sent by the relay device through the proprietary WiFi network;
wherein the third signal is received by the relay device from the local device through the default WiFi network.

7. A data transmission method, comprising:
sending, by a remote device, a first signal to a relay device through a proprietary WiFi network, wherein the relay device is configured to temporarily store or store the first signal, and generating a second signal.

8. The method according to claim 7, wherein a network parameter of the proprietary WiFi network is different from a network parameter of the standard WiFi network;
wherein the network parameter comprises at least one of: a transmission protocol, a transmission mode, a response mechanism, or a channel switching mechanism.

9. The method according to claim 7, wherein a network parameter of the proprietary WiFi network satisfies at least one of:
a b/n hybrid transmission mode is adopted;
a transmission protocol adopted in an 802.11b mode is a Carrier Sense Multiple Access with Collision Avoidance (CSMA/CA) transmission protocol, and a priority of the CSMA/CA transmission protocol is greater than a default priority;
a transmission mode adopted in an 802.11n mode is an Enhanced Distributed Channel Access (EDCA) transmission mode;
a CTS-to-self protection mechanism is adopted;
an adopted response mechanism is to correspond multiple transmission packets with an acknowledgment character (ACK) response and disable ACK management mechanism by hardware (HW) control;
a channel switching mechanism is: a channel switching is performed when a transmission accuracy is less than or equal to a default threshold.

10. The method according to claim 8, wherein the method further comprises:
receiving, by the remote device, a third signal sent by the relay device through the proprietary WiFi network;
wherein the third signal is received by the relay device from the local device through the standard WiFi network.

11. A data transmission method, comprising:
receiving, by a relay device, a first signal sent by a remote device through a proprietary WiFi network;
temporarily storing or storing, by the relay device, the first signal, and sending the first signal to a local device through a default WiFi network;
wherein anti-interference capability of the proprietary WiFi network is greater than anti-interference capability of the default WiFi network, and a transmission distance of the proprietary WiFi network is greater than a transmission distance of the default WiFi network.

12. The method according to claim 11, wherein a network parameter of the proprietary WiFi network is different from a network parameter of the default WiFi network;
wherein the network parameter comprises at least one of: a transmission protocol, a transmission mode, a response mechanism, or a channel switching mechanism.

13. The method according to claim 11, wherein a network parameter of the proprietary WiFi network satisfies at least one of:
a b/n hybrid transmission mode is adopted;
a transmission protocol adopted in an 802.11b mode is a Carrier Sense Multiple Access with Collision Avoidance (CSMA/CA) transmission protocol, and a priority of the CSMA/CA transmission protocol is greater than a default priority;
a transmission mode adopted in an 802.11n mode is an Enhanced Distributed Channel Access (EDCA) transmission mode;
a CTS-to-self protection mechanism is adopted;
an adopted response mechanism is to correspond multiple transmission packets with an acknowledgment character (ACK) response and disable ACK management mechanism by HW control;
a channel switching mechanism is: a channel switching is performed when a transmission accuracy is less than or equal to a default threshold.

14. The method according to claim 11, wherein the method further comprises:
receiving, by the relay device, a third signal sent by the local device through the default WiFi network;
temporarily storing or storing, by the relay device, the third signal, and sending the third signal to the remote device through the proprietary WiFi network.
